(19) United States
(12) Patent Application Publication
(10) Pub. No.: US 2002/0015058 A1
(43) Pub. Date: Feb. 7, 2002

(54) Authentication system and its authentication method, and authentication program

(76) Inventor: Tomihiko Azuma, Tokyo (JP)

Correspondence Address: McGinn & Gibb, PLLC, Suite 200, 8321 Old Courthouse Road, Vienna, VA, 22182-3817, US

(21) Appl. No.: 09/907,916

(22) Filed: Jul. 19, 2001

(30) Foreign Application Priority Data
Jul. 28, 2000 (JP) 228137/2000

(51) Int. Cl. G06F 13/00

(52) U.S. Cl. 345/741

(57) ABSTRACT

An authentication system for authenticating a user based on data entered by the user comprises: a user registration unit for registering a conversion rule for defining a conversion method for converting a given numeral into the other numeral as the information for authenticating a user; an authentication accepting unit for accepting an authentication request from a user terminal of a user through a communication line; a numeral creating unit for creating a numeral and notifying the created numeral to a user; a conversion unit for converting the created numeral based on the conversion rule registered for the user to be authenticated; and a judging unit for receiving conversion result of the created numeral which is obtained based on the conversion rule registered for the user, from the user to be authenticated, collating the conversion result entered by the user to be authenticated with the conversion result by the conversion unit, and determining that the user to be authenticated is a user correctly registered when the both results agree.

### BACKGROUNDS OF THE INVENTION

1. Field of the Invention

The present invention relates to a system for identifying a user, and more particularly to an authentication system and its authentication method for identifying a user by receiving user identifiable input from the user and a storage medium with such an authentication program stored therein.

2. Description of the Related Art

Heretofore, authentication for identifying a user is often performed in a computer system in order to ensure the security, and particularly, it is performed widely in a computer system under multi-user and network circumstances.

Recently, information communication such as the Internet comes into widespread use, and electronic commerce such as on-line shopping over the Internet becomes very popular. Accordingly, an authentication system for identifying a trading person is required in order to do a trade through a network.

As an authentication method, a method of entering a combination of a user ID (identification) and a password is widely used. When a user logs in a computer system or a network, he or she is required to enter the user ID and password. Upon receipt of the input of the both data from the user, the system or the network checks that it agrees with the registered pair of the user ID and password (authentication), and only when the user is authenticated, he or she is permitted to use the system.

In this authentication method, since authentication can be performed by using an input function of letters such as a keyboard provided in an ordinal information processing terminal, it is not necessary to provide with a magnetic card reader and a special instrument for authentication such as a fingerprint discriminating device, a retina discriminating device, and so on. Therefore, this authentication method for identifying a user is suitable to the form of having access from an unspecified number of terminals through a network such as the Internet.

The conventional authentication system, however, has the following problems.

At first, in the conventional authentication by input of a password, there is much risk of leaking a password.

When the other person sees a password entering and the password leaks out, there is a fear that the other person is authenticated, posing as an authorized user, only by entering the password.

When entering a password especially through a portable phone, a PHS, and other portable terminal, these terminals are often used in the crowd, and there is much risk of having the entering password watched by the other and leaking the password out to the other from the motion of a finger.

At second, heretofore, a personal computer or a notebook personal computer provided with a keyboard for entering alphabets is used in order to accept authentication by input of a password and a user ID, and a portable phone, a PHS, and other portable terminal without this keyboard are very inconvenient to use.

If entering alphabets and the like through these portable terminals, a user has to operate a small kind of input buttons in a complicated way. Therefore, these portable terminals have a defect in operation ability and the operation is troublesome.

On the other hand, if forming a password and a user ID only by numerals in order to make it easy to enter them through these portable terminals, kind of the passwords is very narrowed down and there is a risk that the other may accept a fraudulent authentication more easily.

At third, heretofore, a special instrument is required on a user side, in order to adopt a more rigid authentication method than the password input method.

Although a technique of encrypting passwords flowing over a network is used, a user terminal which conforms to this encryption technique is necessary and a user terminal which do not conform to this cannot use the system.

Although a user authentication method by using one-time password which is available only one time is developed, it is necessary for a user to own a special card or to build a special function into a user terminal, and a user terminal which does not conform to this cannot use the system.

### SUMMARY OF THE INVENTION

In order to solve the above conventional problems, a first object of the present invention is to provide an authentication system and its authentication method capable of accepting authentication by easy operation and rigidly preventing a risk of leaking the information for use in authentication outwards, and provide a storage medium with such an authentication program stored therein.

In order to solve the above conventional problems, a second object of the present invention is to provide an authentication system and its authentication method capable of securely accepting authentication even by using a portable phone and a PHS sold on the market, without providing the user side terminal accepting authentication with a special semiconductor circuit and software for authentication, and provide a storage medium with such an authentication program stored therein.

According to the first aspect of the invention, an authentication system for authenticating a user based on data entered by the user, comprises

user registration means for registering a conversion rule for defining a conversion method for converting a given numeral into the other numeral as information for authenticating a user,

numeral creating means for creating a numeral and notifying the created numeral to a user,

conversion means for converting the created numeral based on the conversion rule registered for a user to be authenticated, and

determining means of receiving conversion result of the created numeral which is obtained based on the conversion rule registered for the user, from the user to be authenticated, for collating the conversion result entered by the user to be authenticated with the conversion result by the conversion means and determining that the user to be authenticated is a user registered correctly when the both results agree.

In the preferred construction, the authentication system further comprises an authentication information storing unit for storing a pair of an identifier that is the information for identifying each user and a conversion rule that is the information for authenticating the user, and an authentication accepting unit for accepting an authentication request from the user, wherein

the authentication accepting unit

accepts the authentication request from the user through input of the identifier of the user, retrieves and obtains the conversion rule registered for the user from the authentication information storing unit based on the identifier.

In another preferred construction, an authentication request is accepted from a user terminal owned by a user through a communication line,

the numeral creating means notifies the created numeral to the user terminal through the communication line, and

the determining unit receives the conversion result by the user from the user terminal through the communication line.

In another preferred construction, the authentication system further comprises an authentication information storing unit for storing a pair of an identifier that is the information for identifying each user and a conversion rule that is the information for authenticating the user, and

an authentication accepting unit for accepting the authentication request from the user, wherein

the authentication accepting unit accepts the authentication request from the user through input of the identifier of the user, retrieves and obtains the conversion rule registered for the user from the authentication information storing unit based on the identifier,

an authentication request is accepted from a user terminal owned by a user through a communication line,

the numeral creating means notifies the created numeral to the user terminal through the communication line, and

the determining unit receives the conversion result by the user from the user terminal through the communication line.

In another preferred construction, the user terminal of the user is a portable terminal.

In another preferred construction, the communication line is the Internet.

According to the second aspect of the invention, an authentication method for authenticating a user based on data entered by the user, comprising the following steps of

registering a conversion rule for defining a conversion method for converting a given numeral into the other numeral as information for authenticating a user,

creating a numeral and notifying the created numeral to a user,

converting the created numeral based on the conversion rule registered for a user to be authenticated,

receiving conversion result of the created numeral which is obtained based on the conversion rule registered for the user from the user to be authenticated,

collating the conversion result entered by the user to be authenticated with the conversion result by the conversion means, and

determining that the user to be authenticated is a user registered correctly when the both results agree.

In the preferred construction, the authentication method further comprising the steps of

storing/registering a pair of an identifier that is the information for identifying each user and a conversion rule that is the information for authenticating the user,

accepting an authentication request from the user through input of the identifier of the user, and

retrieving and obtaining the conversion rule registered for the user based on the identifier.

In another preferred construction, the authentication method further comprising the steps of

accepting an authentication request from a user terminal owned by a user through a communication line,

notifying the created numeral to the user terminal through the communication line, and

receiving the conversion result by the user from the user terminal through the communication line.

In another preferred construction, the authentication method further comprising storing/registering a pair of an identifier that is the information for identifying each user and a conversion rule that is the information for authenticating the user,

accepting an authentication request from the user through input of the identifier of the user,

retrieving and obtaining the conversion rule registered for the user based on the identifier,

accepting an authentication request from a user terminal owned by a user through a communication line,

notifying the created numeral to the user terminal through the communication line, and

receiving the conversion result by the user from the user terminal through the communication line.

In another preferred construction, the user terminal of the user is a portable terminal.

In another preferred construction, the communication line is the Internet.

According to another aspect of the invention, an authentication program for authenticating a user based on data entered by the user by controlling a computer, comprising the following functions of

registering a conversion rule for defining a conversion method for converting a given numeral into the other numeral as information for authenticating a user,

creating a numeral and notifying the created numeral to a user,

converting the created numeral based on the conversion rule registered for a user to be authenticated,

receiving conversion result of the created numeral which is obtained based on the conversion rule registered for the user, from the user to be authenticated,

collating the conversion result entered by the user to be authenticated with the conversion result by the conversion means, and

determining that the user to be authenticated is a user registered correctly when the both results agree.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of an authentication system according to a first embodiment of the present invention;

FIG. 2 is a block diagram showing the structure of an embodiment of the authentication system connected by a communication line according to the first embodiment of the present invention;

FIG. 3 is a flow chart for describing registration processing of a user according to the first embodiment of the present invention;

FIG. 4 is a view showing an example of authentication information stored by an authentication information storing unit according to the first embodiment of the present invention;

FIG. 5 is a flow chart for describing the authentication processing according to the fist embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

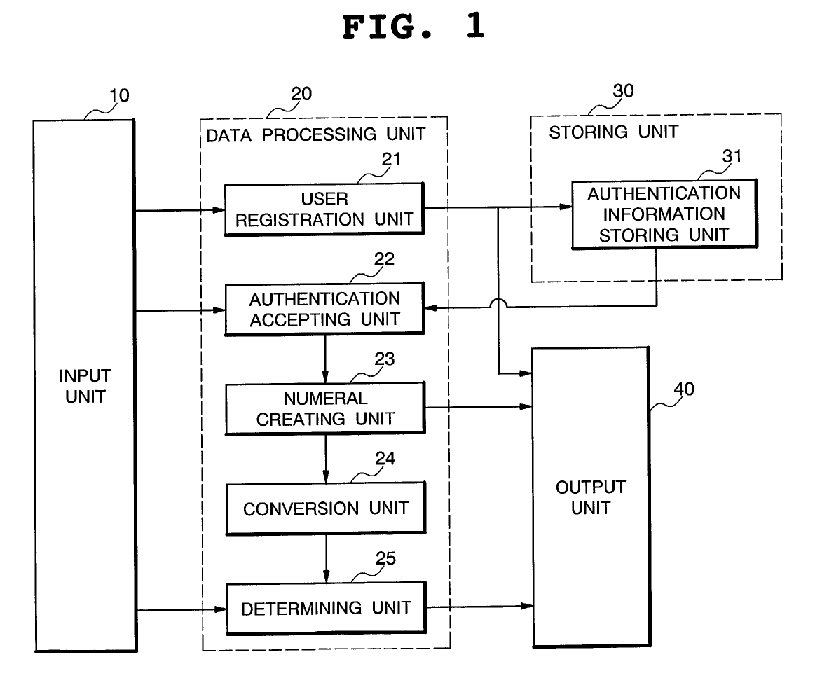

FIG. 1 is a block diagram showing the structure of an authentication system according to a first embodiment of the present invention.

Referring to FIG. 1, the authentication system of the embodiment comprises an input unit 10 for receiving an input of a user, a data processing unit 20 for performing authentication based on the data entered by a user, a storing unit 30 for storing various data necessary for the authentication system, and an output unit 40 for supplying the authentication results and the like.

The storing unit 30 includes an authentication information storing unit 31 for storing data for authenticating each user.

The authentication information storing unit 31 stores a pair of identifier for discriminating a user as the user registration information and a conversion rule for use in user authentication that is a rule for conversion method of numerals (or a progression).

This conversion rule is a rule for converting the numerals expressed in some digits into the other numerals, and the rule is established uniquely for every user to define a conversion. For example, there are a rule for performing computation in a predetermined calculation method, a rule for replacing the values of the respective digits with each other and rearranging the values, and a rule in combination of these conversions.

The data processing unit 20 includes a user registration unit 21 for registering users, an authentication accepting unit 22 for obtaining an authentication method registered for a user to be authenticated with reference to the authentication information storing unit 31, a numeral creating unit 23 for creating a random number for use in authentication, a conversion unit 24 for performing conversion based on the conversion rule registered for the created random number that is the authentication method of the user, and a determining unit 25 for determining the authentication result by collating the number converted by this conversion unit 24 with the number converted and notified by the user.

At user registration, the authentication system of the embodiment registers an identifier for discriminating each user individually as the information for authenticating user's identification and further a conversion rule of the numerals (or a progression) which is established uniquely by each user as the authentication method.

At user authentication, the authentication system starts authentication processing of a user upon receipt of the identifier for discriminating the user, creates a random number, and notifies it to the user.

Upon receipt of the notice of the random number, the user to be authenticated notifies the number into which the random number is converted to the authentication system based on the conversion rule registered in the authentication system as the authentication method.

The authentication system collates the number notified by the user with the correct number into which the created random number is converted based on the registered conversion rule, and when the both numbers agree, it determines that the user is an authorized user registered correctly and it authenticates the user, otherwise, it doesn't authenticate the user.

A description will be given of the function of each unit of the authentication system of the embodiment.

The input unit 10 is a device for a user entering data, and it may be realized by, for example, a keyboard of a personal computer or a notebook personal computer, or input buttons of a portable communication terminal such as a portable phone and a PHS or input buttons of a portable information terminal such as a PDA.

The output unit 40 is a device for supplying the authentication result to a user, and it may be realized by, for example, a display of a personal computer or a notebook personal computer, or a liquid crystal display of a portable communication terminal such as a portable phone and a PHS or of a portable information terminal such as a PDA. The output unit 40 may be designed to supply the authentication result to an outward computer system which accepts the authentication result.

The data processing unit 20, the input unit 10, and the output unit 40 are not restricted to the form formed by these units (for example, electronic lock system), but in the authentication system of the embodiment, these units may assume the form to be connected via a wired or wireless communication network.

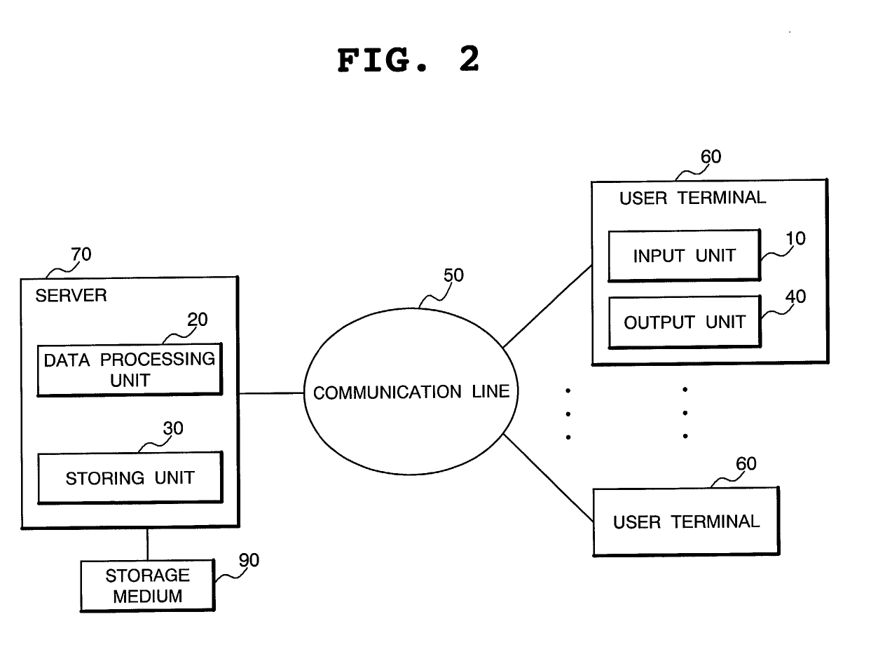

FIG. 2 is a block diagram showing the structure of one embodiment of the authentication system in the embodiment connected by a communication line 50. In this example of FIG. 2, the authentication system of the embodiment comprises a server 70 having the data processing unit 20 and the storing unit 30 for storing authentication information and a user terminal 60 of a user having the input unit 10 and the output unit 40. A user connects the user terminal 60 to the server 70 through the communication line 50, so to do communication for user authentication.

The communication line 50 is an information communication line for authenticating a user through communication between the server 70 and the user terminal 60, and it may use, for example, the Internet, the Internet of the i-mode, the other dedicated line of personal computer communications, a telephone line for connecting these lines, or a wireless telephone line.

As the user terminal 60 of a user, for example, a portable communication terminal of a portable phone or a PHS, and an information terminal of a personal computer, a notebook personal computer, or a PDA can be used.

The server 70 is a compute having a function of accepting the operation from a user through the communication line 50, and it may be formed by a server provided with a function of accepting user's remote log-in or a web server of the Internet.

The user registration unit 21 receives the conversion rule for use in user authentication as the registration information of a user from the input unit 10, and stores and registers a pair of this conversion rule and an identifier for identifying a user in the authentication information storing unit 31, at a newly registration of a user and at an update of the registered content.

At a newly registration of a user, the user registration unit 21 may create an identifier for identifying a user individually, send it to the output unit 40, and notify a user of it.

The authentication accepting unit 22 accepts the identifier for identifying a user from the input unit 10 and obtains the conversion rule for user authentication stored being paired with the identifier from the authentication information storing unit 31.

The numeral creating unit 23 creates a random number for use in user authentication and displays it to the output unit 40.

The conversion unit 24 applies the conversion rule which the authentication accepting unit 22 obtains from the authentication information storing unit 31 to the random number created by the numeral creating unit 23, hence to require the conversion result.

The determining unit 25, upon receipt of the numeral from the input unit 10, compares this numeral with the resultant numeral from conversion by the conversion unit 24, and when the two values agree, it confirms that the user entering the numeral from the input unit 10 is an authorized user, otherwise, it doesn't authenticate the user. In either case, the authentication result is displayed on the output unit 40.

This time, the operation of the authentication system of the embodiment will be described in detail with reference to the drawings.

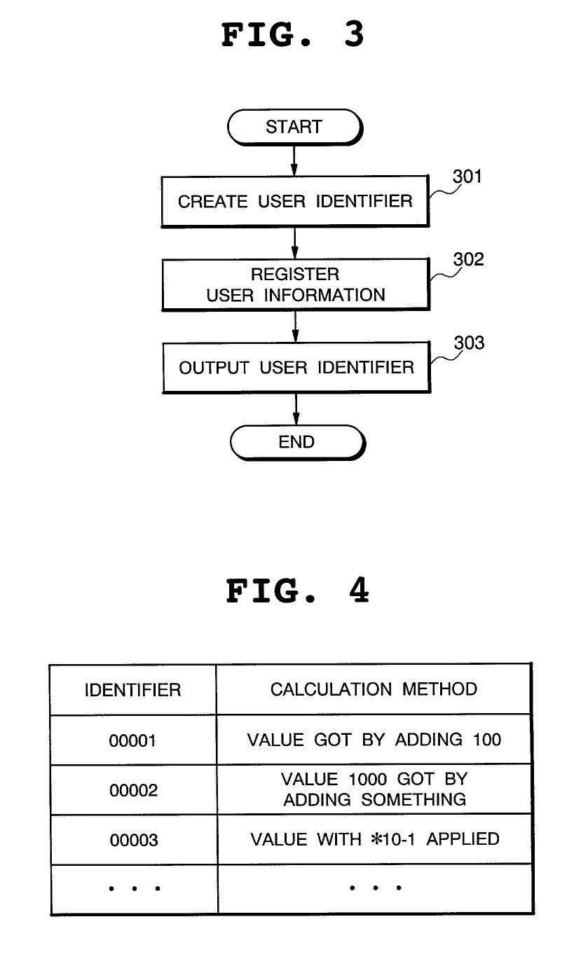

FIG. 3 is a flow chart for describing newly registration processing of a user of the embodiment.

With reference to FIG. 3, the user registration unit 21 at first accepts a registration request of a user from the input unit 10, then accepts the input of the conversion rule for authenticating the user, and creates an identifier for identifying the user (Step 301).

Then, the user registration unit 21 stores and registers a pair of this identifier and the conversion rule of the corresponding user supplied from the input unit 10 into the authentication information storing unit 31 (Step 302).

The created identifier indicating the corresponding user is supplied to the output unit 40 and is notified to the user (Step 303).

In this way, the user registration has been completed, and thereafter, when the user enters the identifier and the conversion rule from the input unit 10, the data processing unit 20 starts authentication processing for the user.

For example, when the user registration unit 21 creates “00003” as the identifier for identifying the user in Step 301, in reply to the notice, “the value with *10-1 applied”, that is the conversion rule for use in user authentication from the input unit 10, the user registration unit 21 stores and registers a pair of the identifier “00003”, and the conversion rule “the value with *10-1 applied” into the authentication information storing unit 31 in Step 302 and notifies the identifier “00003”, of the corresponding user to the output unit 40 in Step 304.

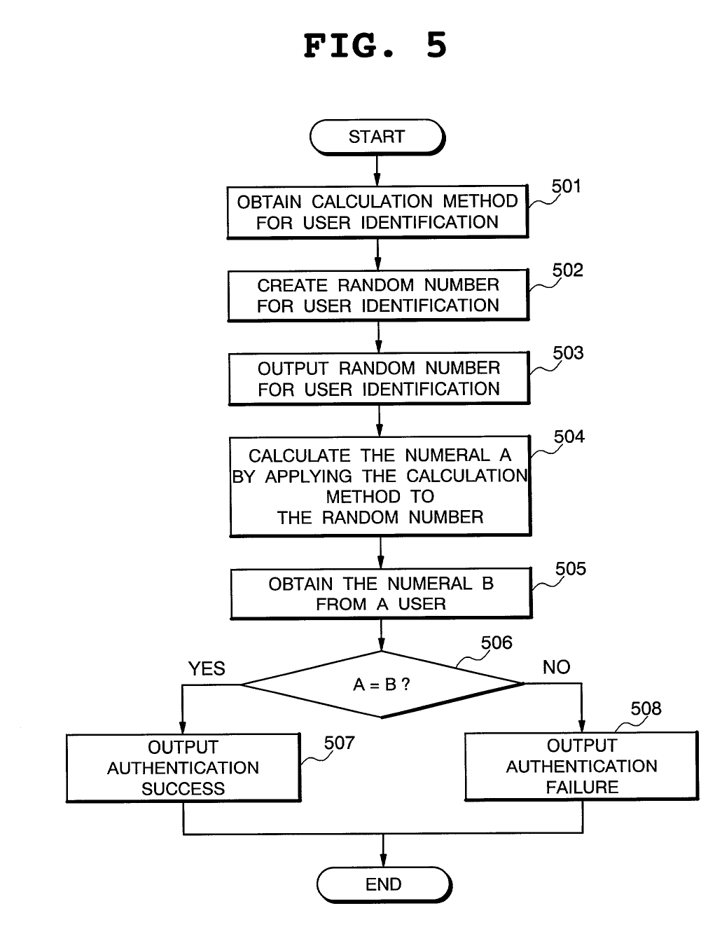

FIG. 4 is a view showing one example of the authentication information to be stored by the authentication information storing unit 31 of the embodiment.

In the example of FIG. 4, the conversion rule “the value got by adding 100” is registered correspondingly to the user having the identifier “00001”; the conversion rule “the value 1000 got by adding something” is registered correspondingly to the user having the identifier “00002”; and the conversion rule “the value with *10-1 applied” is registered correspondingly to the user having the identifier “00003”.

Alternatively, these conversion rules may be stored into the authentication information storing unit 31 not only in a way of a sentence understandable for a user like the above, but also in a way of expression, for example, by a numerical formula and a symbol indicating the conversion result for the created numeral X, like “X+100”, “1000-X”, and “X*10-1”, which expression is more understandable for a computer. Also in the case of defining a conversion of replacing the created numerals with each other in each digit, symbols for the digits are respectively defined to express the conversion in the same way.

FIG. 5 is a flow chart for describing the authentication processing of the embodiment.

With reference to FIG. 5, the user authentication processing of the embodiment starts from receiving the authentication request from a user, by accepting input of the identifier of the user from the input unit 10, and based on the identifier of the user, the authentication information storing unit 31 is searched to obtain the conversion rule for user authentication stored being paired with the identifier (Step 501).

The numeral creating unit 23 creates the numeral for use in user authentication (Step 502), and supplies it to the output unit 40 to notify the user (Step 503). The numeral by this numeral creating unit 23 can be created in a method of creating a random number satisfying predetermined conditions, for example, on a predetermined digit number.

The conversion unit 24 applies the conversion rule registered in the authentication information storing unit 31 to the random number supplied from the numeral creating unit 23 and supplies the correct conversion result to the determining unit 25 (Step 504). Hereinafter, a description will be given with the correct conversion result defined as the numeral A.

A user applies the conversion rule which he or she specified at user registration to the random number shown on the output unit 40 and enters the numeral converted by himself or herself from the input unit 10, and the numeral is accepted by the determining unit 25 (Step 505). Hereinafter, a description will be given with the numeral of the conversion result by this user defined as the numeral B.

The determining unit 25 compares the numeral A obtained by the conversion unit 24 with the numeral B obtained from the input unit 10 (Step 506): when the both values agree, authentication success is supplied to the output unit 40 (Step 507); and when the both values do not agree, authentication failure is supplied to the output unit 40 (Step 508).

The authentication processing of FIG. 5 will be now described with a concrete example.

Here, a description will be given in the case where a user requests the authentication with his or her own identifier “00003” when the authentication information is registered like in the example of FIG. 4.

The authentication accepting unit 22 retrieves the authentication information storing unit 31 based on the identifier “00003”, so to obtain the authentication method of the user corresponding to the identifier (Step 501). With reference to FIG. 4, “the value with *10-1 applied”, that is to the effect that the numeral X notified to the user should be converted into the value of “X*10-1” is established in the numeral conversion rule that is the authentication method of the user.

The numeral creating unit 23 creates “10” as the random number for use in user authentication (Step 502), and notifies it to the output unit 40 in order to display “10” on the output unit 40 (Step 503).

The conversion unit 24 can obtain “99” as the numeral A of the correct conversion result from applying the conversion rule “*10-1” obtained by the authentication accepting unit 22 from the authentication information storing unit 31 to the random number “10” created by the numeral creating unit 23 (Step 504).

The user applies the conversion rule “*10-1” in his or her own memory to the random number “10” for authentication shown on the output unit 40 and enters the conversion result from the input unit 10.

When the user enters “99” correctly as the numeral B from the input unit 10, the “99” is supplied to the determining unit 25 as the numeral B (Step 505), it is compared with the numeral A resultant from the conversion by the conversion unit 24 (Step 506), and the output unit 40 displays that the user succeeds in user authentication because the numerals A and B are both “99” (Step 507).

If the user enters the value other than “99” as the numeral B from the input unit 10, the output unit 40 displays that the user fails in authentication because the numerals A and B do not agree (Step 508).

Here, since the numeral “99” entered by the user is effective only once, there is no risk of making a fraudulent use of it even if the other sees the input of the numeral and even if the numeral entered on a network is fraudulently intercepted.

Further, even if a pair of the numeral “10” sent from the data processing unit 10 and the numeral “99” sent by the user is known to the other, it is difficult to recognize the conversion rule “*10-1” for use in authentication only by this pair, thereby preventing leakage rigidly.

Extremely many kinds of conversion rules can be defined even if the rule adopts such a simple calculation method that a user can calculate by heart like in this example.

A user can calculate the conversion values by heart, thereby saving a special storage and calculator on the side of the input unit and saving a trouble of using the other calculator and a memo pad.

According to the authentication system of the embodiment as mentioned above, a user can accept authentication by easy operation, while efficiently avoiding a risk of leaking the information for use in user authentication, even if using a portable phone and a PHS that is a small portable terminal without providing with a keyboard for entering alphabets.

The user terminal 60 that is a terminal for a user accepting authentication is not restricted only to a portable terminal such as a portable phone and a PHS, but it may use a terminal of a personal computer or a notebook personal computer selectively.

In the embodiment of FIG. 2, although it is the circumstances under which a plurality of user terminals 60 establish a connection with the communication line, the present invention is not restricted to this form, but also it can adopt the form in which a personal computer used by a user is regarded as the server 70 of the embodiment and only the user can be authenticated.

It is needless to say that the authentication system of the embodiment can realize the functions of the user registration unit 21, the authentication accepting unit 22, the numeral creating unit 23, the conversion unit 24, and the determining unit 25, and the other functions by hardware in the data processing unit 20, and also it can realize these functions by loading a computer program having these functions into a memory of a computer processing unit. This computer program is stored in the storage medium 90 such as a magnetic disk, a semiconductor memory, and so on. Then, it is loaded into a computer processing unit from the storage medium, thereby realizing the above-mentioned functions while controlling the operation of the computer processing unit.

As set forth hereinabove, the authentication system of the present invention has the following effects.

At first, since conversion rules of numerals (or a progression) are used for user authentication, a user can be authenticated by an easy operation and a risk of leaking information for use in authentication outwards can be prevented rigidly.

Even if a user has his or her finger motion seen by the other, since the numeral to be entered varies every time, a risk of making a fraudulent use of it can be avoided.

At second, since authentication can be performed only by the input of numerals, terminals of portable phones or PHSs sold on the market are available as a user's terminal to be authenticated.

Recently, these portable terminals are rapidly coming into widespread use. Accordingly, the authentication system of the present invention can regard these numerous users of the portable terminals as an object to be authenticated.

At third, it is not necessary to provide a user terminal with a special semiconductor circuit or software for authentication, but a user can accept authentication at will using a terminal such as a portable phone or a PHS sold on the market.

Although there are various kinds of portable phones and portable information terminals sold on the market with various functions, a function necessary for the authentication system of the present invention is only a function for entering numerals and performing communication. Therefore, it is not restricted to a special type, but various types of portable phones and portable information terminals can be used for authentication as they are without adding any function there.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. An authentication system for authenticating a user based on data entered by the user, comprising:
user registration means for registering a conversion rule for defining a conversion method for converting a given numeral into the other numeral as information for authenticating a user;
numeral creating means for creating a numeral and notifying the created numeral to a user;
conversion means for converting the created numeral based on the conversion rule registered for a user to be authenticated; and
determining means of receiving conversion result of the created numeral which is obtained based on the conversion rule registered for the user, from the user to be authenticated, for collating the conversion result entered by the user to be authenticated with the conversion result by the conversion means and determining that the user to be authenticated is a user registered correctly when the both results agree.

2. The authentication system as claimed in claim 1, further comprising:
an authentication information storing unit for storing a pair of an identifier that is the information for identifying each user and a conversion rule that is the information for authenticating the user; and
an authentication accepting unit for accepting an authentication request from the user, wherein
the authentication accepting unit
accepts the authentication request from the user through input of the identifier of the user, retrieves and obtains the conversion rule registered for the user from the authentication information storing unit based on the identifier.

3. The authentication system as claimed in claim 1, wherein
an authentication request is accepted from a user terminal owned by a user through a communication line,
the numeral creating means
notifies the created numeral to the user terminal through the communication line, and
the determining unit
receives the conversion result by the user from the user terminal through the communication line.

4. The authentication system as claimed in claim 1, further comprising:
an authentication information storing unit for storing a pair of an identifier that is the information for identifying each user and a conversion rule that is the information for authenticating the user; and
an authentication accepting unit for accepting the authentication request from the user, wherein
the authentication accepting unit
accepts the authentication request from the user through input of the identifier of the user, retrieves and obtains the conversion rule registered for the user from the authentication information storing unit based on the identifier;
an authentication request is accepted from a user terminal owned by a user through a communication line;
the numeral creating means
notifies the created numeral to the user terminal through the communication line; and
the determining unit
receives the conversion result by the user from the user terminal through the communication line.

5. The authentication system as claimed in claim 3, wherein
the user terminal of the user is a portable terminal.

6. The authentication system as claimed in claim 3, wherein
the communication line is the Internet.

7. An authentication method for authenticating a user based on data entered by the user, comprising the following steps of:
registering a conversion rule for defining a conversion method for converting a given numeral into the other numeral as information for authenticating a user;
creating a numeral and notifying the created numeral to a user;
converting the created numeral based on the conversion rule registered for a user to be authenticated;
receiving conversion result of the created numeral which is obtained based on the conversion rule registered for the user from the user to be authenticated;
collating the conversion result entered by the user to be authenticated with the conversion result by the conversion means; and
determining that the user to be authenticated is a user registered correctly when the both results agree.

8. The authentication method as claimed in claim 7, further comprising the steps of:
storing/registering a pair of an identifier that is the information for identifying each user and a conversion rule that is the information for authenticating the user;
accepting an authentication request from the user through input of the identifier of the user; and
retrieving and obtaining the conversion rule registered for the user based on the identifier.

9. The authentication method as claimed in claim 7, further comprising the steps of:
accepting an authentication request from a user terminal owned by a user through a communication line;
notifying the created numeral to the user terminal through the communication line; and
receiving the conversion result by the user from the user terminal through the communication line.

10. The authentication method as claimed in claim 7, further comprising:
storing/registering a pair of an identifier that is the information for identifying each user and a conversion rule that is the information for authenticating the user;
accepting an authentication request from the user through input of the identifier of the user;
retrieving and obtaining the conversion rule registered for the user based on the identifier;
accepting an authentication request from a user terminal owned by a user through a communication line;
notifying the created numeral to the user terminal through the communication line; and
receiving the conversion result by the user from the user terminal through the communication line.

11. The authentication method as claimed in claim 9, wherein
the user terminal of the user is a portable terminal.

12. The authentication method as claimed in claim 9, wherein
the communication line is the Internet.

13. An authentication program for authenticating a user based on data entered by the user by controlling a computer, comprising the following functions of:
registering a conversion rule for defining a conversion method for converting a given numeral into the other numeral as information for authenticating a user;
creating a numeral and notifying the created numeral to a user;
converting the created numeral based on the conversion rule registered for a user to be authenticated;
receiving conversion result of the created numeral which is obtained based on the conversion rule registered for the user, from the user to be authenticated;
collating the conversion result entered by the user to be authenticated with the conversion result by the conversion means; and
determining that the user to be authenticated is a user registered correctly when the both results agree.

14. The authentication program as claimed in claim 13, further comprising the functions of:
storing/registering a pair of an identifier that is the information for identifying each user and a conversion rule that is the information for authenticating the user;
accepting an authentication request from the user through input of the identifier of the user; and
retrieving and obtaining the conversion rule registered for the user based on the identifier.

15. The authentication program as claimed in claim 13, further comprising the functions of:
accepting an authentication request from a user terminal owned by a user through a communication line;
notifying the created numeral to the user terminal through the communication line; and
receiving the conversion result by the user from the user terminal through the communication line.

16. The authentication program as claimed in claim 13, further comprising the functions of:
storing/registering a pair of an identifier that is the information for identifying each user and a conversion rule that is the information for authenticating the user;
accepting an authentication request from the user through input of the identifier of the user;
retrieving and obtaining the conversion rule registered for the user based on the identifier;.
accepting an authentication request from a user terminal owned by a user through a communication line;
notifying the created numeral to the user terminal through the communication line; and
receiving the conversion result by the user from the user terminal through the communication line.
